(19) United States
(12) Patent Application Publication
(10) Pub. No.: US 2004/0168898 A1
(43) Pub. Date: Sep. 2, 2004

(54) Push-button switch-use member and production method therefor

(76) Inventors: Mikio Kiyosawa, Shiojiri-shi (JP); Takashi Kawamura, Kodama-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/484,448

(22) PCT Filed: Sep. 4, 2002
(86) PCT No.: PCT/JP02/08980

(30) Foreign Application Priority Data
Sep. 21, 2001 (JP) 2001-289892

(51) Int. Cl. H01H 1/02

(52) U.S. Cl. 200/511

(57) ABSTRACT

In a push-button switch member provided with a movable contact composed of a metal member 7 constituting a contact surface to an opposing electrode 4, a number of holes 6 are formed to the contact surface in the height direction thereof, and the holes 6 are filled up with a filler 8 formed of a flexible resin.

### TECHNICAL FIELD

The present invention relates to a member for a push-button switch provided with a metal member contacting an opposing electrode, and more specifically, to a member for a push-button switch and manufacturing method of the same hardly causing a conductive fault even in the presence of a fine insulating foreign material between the push-button switch member and the opposing electrode.

### BACKGROUND ART

In a push-button switch utilized for a power window, door mirror or like, high current of 100 to 500 mA is conducted, so that a plate-shaped metal member is used as a member for the push-button switch (which may be merely called here in later a push-button switch member). Further, in a normally-closed type contact, in order to prevent a so-called sticking phenomenon in which the push-button switch member is closely contacted to the opposing electrode and is never separated therefrom, a plate-shaped metal member is used as the push-button switch member.

FIG. 7 is a schematic partial sectional view showing a push-button switch capable of withstanding such a high current.

In this figure, reference numeral 1 denotes a contact structure composed of a plate-shaped metal, a keypad 2 is formed of a resin such as silicone rubber which is operatively pushed from an external side, and the contact structure 1 is integrally formed to the keypad 2 in a manner opposing to an opposing electrode 4 of a stationary substrate 3 so as to be capable of being contacted to the contact structure 1, thus constituting a movable contact.

In a conventional technology, there has been widely used a metal plate, which is formed by gold-plating a German silver metal sheet and then punched out therefrom in a predetermined shape. At a time when such contact structure 1 is contacted to the opposing electrode 4, since a current passes through the contacting of such metal plate having good conductive performance to the opposing electrode 4, high current can be conducted, and moreover, since the metal plate has a strength strong enough to substantially prevent the contact structure 1 from being damaged or broken through repeated pushing or pressing operation given to a push-button B, and hence, enough to provide desired durability.

However, in the contact structure 1 composed of such plate-shaped metal, the metal plate has too high strength to deform the same. Accordingly, as shown in FIG. 8, if fine foreign material 5 such as dirt or dust having insulating property intrudes into the switch and adheres to a portion between the contact structure 1 and the opposing electrode 4, it is difficult for the metal plate to be deformed in accordance with the shape of the fine foreign material 5 at a time when the contact structure 1 contacts the opposing electrode 4, which will adversely result in formation of wide gap 5a therebetween, largely reduce a contacting area and, hence, causes defective conduction of the push-button switch, thus providing problems.

### DISCLOSURE OF THE INVENTION

The present invention therefore provides a member for a push-button switch positively preventing reduction of contacting area of a contact structure and an opposing electrode both constituting a movable contact even if insulating foreign material exists between the contact structure and the opposing electrode and providing an improved durability, and also provides a manufacturing method capable of easily manufacturing such push-button switch member.

In order to achieve such object, the first invention provides a member for a push-button switch having a movable contact made of a metal member consisting of a contact surface to be contacted to an opposing electrode, in which a number of holes are formed to the contact surface so as to extend in a height direction thereof and the holes are filled up with a filler formed of flexible resin.

According to this invention, at a time of contacting the member for push-button switch to the opposing electrode, even in the presence of insulating foreign material in the holes formed to the contact surface between the opposing electrode and the contact structure, it is possible, for the insulating foreign material having a size smaller than the sectional area of the hole, to intrude into the holes, so that contacting area between the opposing electrode and the end portion of the metal wall of the metal member surrounding the hole constituting the contact surface is not reduced. Furthermore, even in the presence of the insulating foreign material to the end portion of the metal wall sectioning the adjacent holes, the metal member can be easily deformed because of the formation of number of holes, so that the metal member can be locally deformed in accordance with the insulating foreign material, and the contacting area is thus not reduced so largely. Therefore, even in the presence of the insulating foreign material having a size smaller than the sectional area of the hole between the push-button switch member and the opposing electrode, sufficient contacting area can be ensured, thus hardly causing conductive fault or conduction trouble. Moreover, even if the end portion of the metal wall of the metal member is easily deformed, the metal wall surrounding each of the holes oriented in a height (depth) direction thereof has a solid structure, so that the metal member can provide a desired strength as the whole, thus ensuring the durability.

Furthermore, since the holes are filled up with the filler formed of flexible resin, the wall section between the adjacent-holes can be reinforced by the filler, and in addition, since the filler is formed of flexible resin, the local deformation of the metal member cannot be adversely obstructed. Therefore, the metal member even having a thin wall can be hardly broken by the repeated local deforming force, thus improving the durability.

The second invention is characterized, in addition to the first invention, in that the filler is filled up in the full height direction of the metal member.

According to this invention, the end portion of the filler provides a same flat surface as that of the end portion of the metal wall and the metal wall can be entirely reinforced by the filler, so that the excellent durability can be provided. Moreover, even if the insulating foreign material intrudes into the holes, the insulating foreign material can be easily separated from the holes, at the time when the push-button switch member is separated apart from the opposing electrode, by the elastic recovering force of the end portion of the filler, so that the repeated use in normal condition can be always ensured.

The third invention is characterized, in addition to the first and second inventions, in that the metal member has a honeycomb shape densed structure formed with a number of through holes having same sectional shape.

According to this invention, in addition to the first and second inventions, the strength in the full height direction of the metal member can be made higher, and the metal wall between the adjacent through holes can also be made thinner, so that the flexibility of the end portion of the metal wall can be further improved while maintaining the improved durability.

The fourth invention is a method of manufacturing a member for push-button switch provided with a movable contact composed of a metal member constituting a contact surface to an opposing electrode, which is characterized by comprising the steps of forming a number of through holes to the metal member so as to penetrate in a height direction thereof, arranging a filler formed of a flexible resin sheet on one end surface side of the metal member, forming a metal member base material in which the through holes are filled up with the filler by the full height amount by pressurizing the metal member in the height direction thereof, punching out the metal member base material so as to provide a contact structure having a predetermined shape, and joining the contact structure to a keypad.

According to this invention, the metal member which is made deformable by the formation of a number of through holes is reinforced by the filler, so that the deformation of the metal member in the punching-out step or steps thereafter can be prevented and the degree of flatness of the contact surface in the manufacturing process cannot be damaged. Accordingly, the member for the push-button switch can be easily manufactured.

### BRIEF DESCRIPTION OF THE DRAWINGS

FIG. 1 is a plan view of a metal member of a contact structure of a push-button switch member according to an embodiment of the present invention.

FIG. 2 shows a vertical section of an essential portion of the contact structure of FIG. 1.

FIG. 3 is an enlarged view of one end of the contact structure of FIG. 1.

FIG. 4 is a view explaining a state that an insulating foreign material exists between a filler of the contact structure and the opposing electrode.

FIG. 5 is a view explaining a state that an insulating foreign material exists between a metal member of the contact structure and the opposing electrode.

FIG. 6 is a sectional view for explaining a manufacturing process of the contact structure and includes FIG. 6A showing a state that a through hole is formed to a metal sheet, FIG. 6B showing a filler sheet laminated on one side surface of the metal sheet, and FIG. 6C showing a product formed by filling the filler into the through hole.

FIG. 7 is a schematic sectional view showing a conventional push-button switch.

FIG. 8 is a sectional view of an essential portion showing a contacting state between a conventional contact structure composed of a plate-shaped metal and an opposing electrode.

### BEST MODE FOR EMBODYING THE INVENTION

A mode for embodying the present invention will be described hereunder with reference to the accompanying drawings.

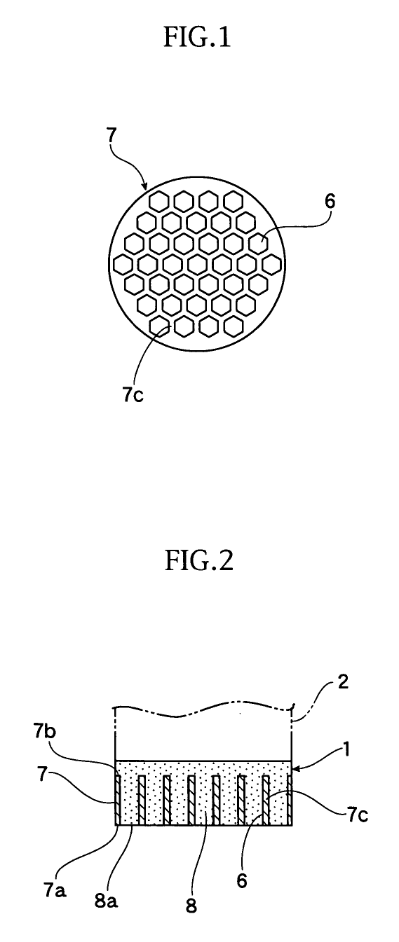

A contact structure of a push-button switch member according to the embodiment of the present invention is shown in FIGS. 1 and 2. Further, it is to be noted that a state that this contact structure is applied to a keypad is identical to that shown in FIG. 8.

FIG. 1 is a plan view of a metal member of the contact structure. FIG. 2 is a vertical view of an essential portion of the contact structure of the push-button switch member.

This contact structure 1 is provided with a metal member 7 having a densed structure of substantially honeycomb shape formed with a plurality of through holes 6, which have the same sectional shape, penetrating in a height (depth) direction thereof and also provided with a filler 8 formed of flexible resin such as silicone rubber filling the through holes 6 of the metal member 7 from the side of a keypad 2. In the illustrated example, the filler 8 is arranged so that one end portion 8a of the filler 8 has substantially the same plane of one end portion 7a, in the height direction, of the metal member 7, and there exists no filler 8 on the outer surface of the end portion 7a, thus constituting a contact surface to the opposing electrode 4. On the other hand, there may exist the filler 8 on the other end portion 7b of the metal member 7, and the metal member 7 is joined to the keypad 2 through the filler 8 existing on the side of the other end portion 7b.

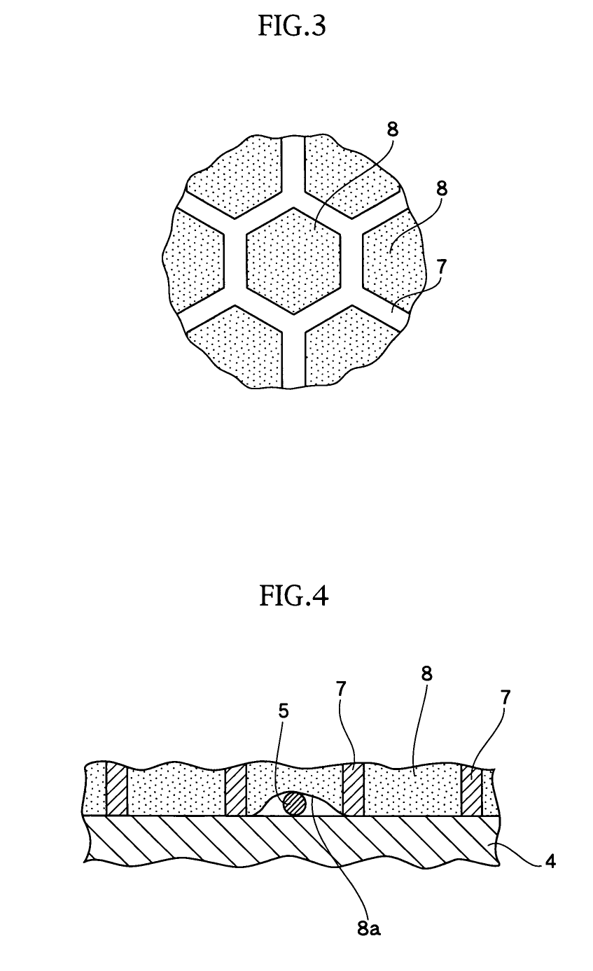

Further, herein, the honeycomb shape densed structure of the metal member 7 indicates a structure, as shown in FIG. 3, in which a plurality of mutually adjacent through holes 6 are formed close to each other through metal walls 7c having equal height smaller than the height of the metal member 7. That is, it is not always necessary for the through hole 6 to have the same sectional shape of hexagon as that of the honeycomb structure, and it may possible to have other polygonal shape such as triangle, pentagonal or octagonal shape, or even to have a circular shape. The metal walls 7c, each constituting a boundary between the adjacent two through holes 6, are all continuous, and in order to provide the metal walls 7c having even thickness, the sectional shape of the through hole 6 may be selected from triangle, quadrangle or hexagonal shape.

According to the contact structure 1 of the structure mentioned above, by pushing the keypad 2 so as to abut against the opposing electrode 4, one end 7a of the metal member 7 contacts the opposing electrode 4, thus being conductive.

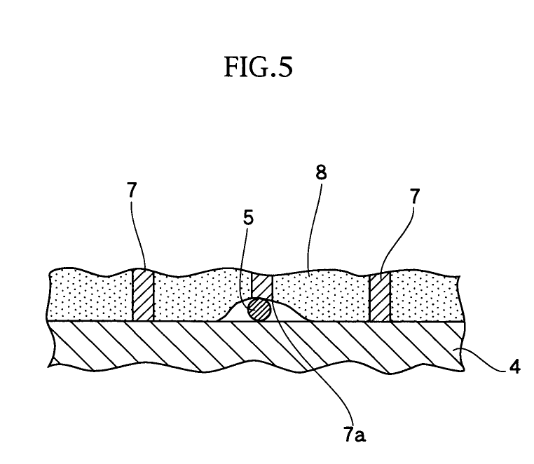

In this situation, at a time when a fine insulating foreign material 5 having a size smaller than the sectional area of the through hole 6 adheres to the contact structure 1 and/or opposing electrode 4, the insulating foreign material 5 is clamped between the contact structure 1 and the opposing electrode 4 at the time of contacting. In the state of FIG. 4, the insulating foreign material 5 is clamped between the end portion 8a of the filler 8 and the opposing electrode 4, and in the state of FIG. 5, the insulating foreign material 5 is clamped between the end portion 7a of the metal member 7 and the opposing electrode 4.

As shown in FIG. 4, showing the contact structure 1, in which the insulating foreign material 5 is clamped between the end portion 8a of the filler 8 and the opposing electrode 4, the filler 8 is deformed by the insulating foreign material 5 and the foreign material 5 intrudes into the through hole 6, so that the contacting area between the end portion 7a of the metal member 7 and the opposing electrode 4 is never reduced.

On the other hand, as shown in FIG. 5, showing the contact structure 1, in which the insulating foreign material 5 is clamped between the end portion 7a of the metal member 7 and the opposing electrode 4, since the metal walls 7c of the metal member 7 have thin thickness and are arranged in the separated fashion via the through holes 6, it is easy to locally deform the metal walls 7c, and accordingly, the metal member 7 can be locally deformed in accordance with the shape of the insulating foreign material 5. Because of this reason, even in the presence of the insulating foreign material 5, the contacting area between the end portion 7a of the metal member 7 and the opposing electrode 4 is not largely reduced. This tendency will be likely observed in a case of an insulating foreign material 5 having a size slightly larger than the sectional area of the through hole 6.

That is, according to the contact structure mentioned above, even in the case where the insulating foreign material 5 such as dust or dirt intruding into the switch member exists between the opposing electrode 4 and the push-button switch member 1, since a plurality of through holes 6 are formed to the end portion 7a of the metal member 7, the insulating foreign material 5 intrudes into the through holes 6 or the metal member 7 is locally deformed in accordance with the insulating foreign material 5 to thereby suppress the reduction of the contacting area, thus being difficult to cause a defective conduction.

Moreover, different from a structure in which the metal member 7 is merely formed to be thin, the metal walls 7c provide a solid structure by a plurality of through holes 6 oriented in the height direction, so that it is possible to sufficiently ensure the entire strength of the metal member 7, thus preventing the degradation of the durability of the contact structure.

Furthermore, since the through holes 6 are filled up with the filler 8, the structure can be reinforced by the filler 8 even if the metal wall 7c is formed to be thin, and moreover, since this filler 8 is formed of a flexible resin material, it is permitted for the metal member to be locally deformed. Thus, the thin metal wall 7c can be subjected to the repeated local deformation and the durability.,of the structure can be hence ensured.

In order to obtain a desired reinforcing effect, it is preferred to use the filler 8 of the filling amount satisfying at least more than ½ height of the metal member 7, and specifically, by filling up to the full height of the through hole 6 so that the end portion 8a of the filler 8 reaches to the same plane as the end portion 7a of the metal wall 7c, all the metal walls 7c are reinforced by the filler 8, so that the further improved durability is obtainable. Moreover, even if the insulating foreign material 5 intrudes into the through hole 6, the insulating foreign material 5 can be easily removed from the through hole 6, at the time of separation of the contact structure 1 from the opposing electrode 4, due to the elastic restoring force of the end portion 8a of the filler 8, so that the contact structure can be repeatedly used always in the stable condition.

Furthermore, since the metal member 7 has approximately a honeycomb shape densed structure, the metal member 7 can provide high mechanical strength in its height direction, and at any portion of the end portion 7a of the metal member 7, it is possible to make thinner the thickness of the metal walls 7c, thus making the contact surface more flexible while suitably maintaining the durability.

Still furthermore, since the metal member 7 is formed from a sheet member formed with a number of through holes 6, and accordingly, the end portion 7a, constituting the contacting surface, of the metal wall 7c of the metal member 7 is formed to provide a plane shape, so that it is possible to make larger the contacting area in comparison with a structure in which a member such as metal mesh, which is formed by knitting warp and weft wires or like each having a diameter substantially identical to the thickness of the metal wall 7c, contacts at points separated from each other, and in addition, the pressure on the contacting surface and the stress applied to the metal wall 7c are made uniform, so that the structure provides less fatigue even in the repeated use and the suitable durability can be maintained.

In the illustrated embodiment, although the metal member 7 is formed with the through holes 6 penetrating in the height direction thereof, it is not always necessary for the through holes 6 to penetrate the same in the height direction as far as the metal member 7 is formed, at least at its contact surface, with holes extending in the height direction of the metal member 7 from the contact surface. In other words, in such structure, even if the insulating foreign material 5 having a size smaller than the holes adheres to the contact surface, the material 5 invades into the hole formed to the contact surface of the metal member 7, so that the contacting area between the end portion 7a of the metal member 7 and the opposing electrode 4 is never reduced, and hence, the conductive performance is never deteriorated.

Hereunder, a manufacturing method of the push-button switch member 1 adopting such contact structure 1 as that mentioned above will be described.

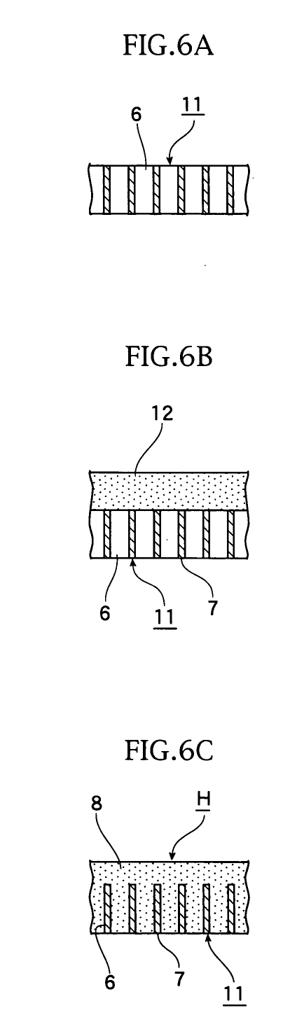

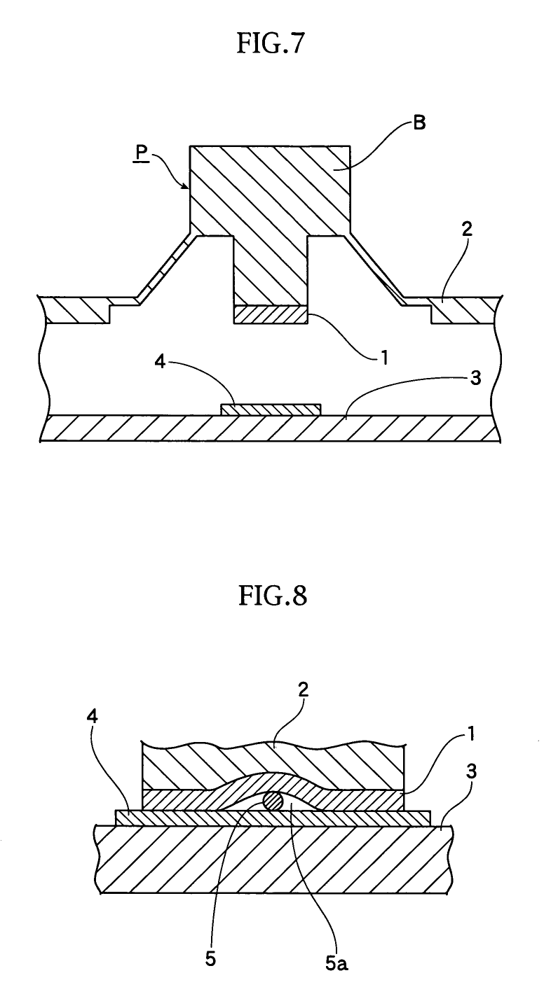

In order to manufacture the contact structure 1 shown in FIG. 1, a number of through holes 6, which penetrate a metal sheet in its height direction, are formed to the metal sheet through, for example, an etching treatment to thereby obtain a metal sheet 11 having densed structure in form of honeycomb structure. The metal sheet 11 is then subjected to a primer treatment, and as shown in FIG. 6b, a filler sheet 12 made of silicone rubber is laminated on one side surface of the metal sheet 11. Thereafter, such filler sheet 12 is pressurized in the height direction by means of predetermined mold and then heated so as to provide an integrated structure. According to such process, as shown in FIG. 6c, a base material H of the metal body is produced in which a number of through holes 6 are filled up with the filler in their full height direction. In this process, attention is paid so that the filler 8 remains on one side surface of the metal body base material H, but it does not exist on the other side surface thereof. The thus formed metal sheet is punched out in a predetermined shape to thereby obtain the contact structure 1 such as shown in FIG. 1.

Further, by joining the keypad 2 formed of silicone rubber to the surface on which the filler 8 exists, the filler 8 and the keypad 2 provide the same material, and therefore, a member P for the push-button switch in which these materials are integrated can be easily completed.

In such manufacturing method of the contact structure 1, since the filler sheet 12 is arranged to the metal sheet 11 having a number of through holes 6 formed so as to penetrate in the height direction, which is then pressurized in the height direction, it is easy to fill the through holes 6 with the filler 8. Moreover, the metal sheet 11 is punched out so as to provide a predetermined shape with the through holes 6 being filled up with the filler 8, so that the metal member 7, which is easily deformable because of the formation of a number of through holes 6, can be reinforced by the filler 8, and the metal member 7 can be prevented from being deformed at the punch-out process of the metal sheet or joining process to the keypad 2. Accordingly, the degree of flatness of the end portion 7a constituting the contact surface will be easily maintained, thus being easy to manufacture the member P for the push-button switch.

Examples of the present invention will be next described hereunder.

### EXAMPLE 1

A metal sheet 11 having a densed structure, in which a number of through holes 6, each having a hexagonal shape, are arranged so as to provide a honeycomb structure was manufactured by performing an etching treatment to a metal sheet formed of SUS304 having a thickness of 50 μm. In the thus manufactured metal sheet 11, the end portions 7a, 7b of the metal wall 7c had a thickness (line width, hereinlater) of 20 μm, a width between the parallel metal walls 7c, 7c (space width, hereinlater) was 185 μm, the sectional area of the through hole 6 (hole area, hereinlater) was 29640 μm², the hole area/metallic portion area of metal member (opening, hereinlater) was 81.4%, and the filling rate (100 minus opening) was 18.6%.

The primer treatment was then effected in a manner such that a primer No. 18 (manufactured by Shin-Etsu Chemical Co., Ltd.) was coated on one side of the metal sheet having a densed structure in form of a honeycomb shape by using a brush, which was then dried for one hour in an environment of a temperature of 200° C.

A laminated body was obtained by bonding, to this primer treatment surface, a filler sheet 12, which was prepared by a silicone rubber (which was prepared by mixing silicone compound KE-951U of 100 parts by weight, manufactured by Shin-Etsu Chemical Co., Ltd. and a cross-linking agent C-8 of 2 parts by weight, manufactured by Shin-Etsu Chemical Co., Ltd.) and having a height of 1.0 mm.

In the next process, this laminated body was placed in a predetermined mold and then formed under compression at a temperature of 160° C. and a pressure of 180 kg/cm² for 5 minutes, thus obtaining a product in shape of sheet in which a number of through holes 6 were filled up with silicone rubber in their full height direction.

The thus obtained product was then punched out so as to provide a predetermined shape to thereby obtain the contact structure 1.

Furthermore, the thus obtained contact structure 1 was placed in the mold for formation of the predetermined keypad with the surface covered by the silicone rubber being directed upward, and a silicone rubber sheet, which was formed of a silicone rubber (which was prepared by mixing silicone compound KE-941U of 100 parts by weight, manufactured by Shin-Etsu Chemical Co., Ltd. a cross-linking agent C-8 of 2 parts by weight, manufactured by Shin-Etsu Chemical Co., Ltd.) and having a height of 2.0 mm, which was then formed under compression at a temperature of 175° C. and a pressure of 200 kg/cm² for 5 minutes, thus obtaining a member P for push-button switch composed of an integrated body of the contact structure 1 and the keypad 2.

The thus manufactured member P for the push-button switch was applied to the push-button switch such as shown in FIG. 1, and a predetermined number of insulating foreign materials 5, each being substantially spherical and having a particle diameter of 50 μm, were distributed almost evenly on the opposing electrode 4. In this state, the electrical characteristics were measured for carrying out conduction test.

In such conduction test, the number of arranged insulating foreign materials 5 was changed and the number of times the switch was pressed was also changed to thereby measure a voltage drop value under a voltage of DC12V and load of 500 mA. The switch pressing was performed at 3.3 times/sec with a load of 200 g. The test result is shown in Table 1.

### Comparative Example 1

A member for the push-button switch was manufactured by substantially the same conditions as those in the Example 1 except that the through holes 6 were not formed to the metal sheet 11 and the same conduction test as that of the Example 1 was performed. The test result is shown in Table 1.

TABLE 1
(Unit: V)

| | The | | | | | | | |
|---|---|---|---|---|---|---|---|---|
| | Number | | | | | | | |
| | of Times | | | | | | | |
| | The | The Number | | | | | | |
| | Switch | of Arranged Insulating | | | | | | |
| Classifi- | Was | Foreign Materials | | | | | | |
| cation | pressed | 1 | 5 | 10 | 15 | 20 | 40 | 60 |
| Example 1 | 0 | 0.27 | 0.26 | 0.28 | 0.26 | 0.27 | 0.27 | 0.27 |
| | 1 | 0.28 | 0.28 | 0.29 | 0.28 | 0.27 | 0.28 | 0.28 |
| | 100 | 0.28 | 0.28 | 0.28 | 0.26 | 0.27 | 0.27 | 0.27 |
| | 300 | 0.29 | 0.29 | 0.28 | 0.28 | 0.29 | 0.28 | 0.28 |
| | 500 | 0.28 | 0.28 | 0.29 | 0.30 | 0.30 | 0.29 | 0.29 |
| Compar- | 0 | 0.27 | 0.28 | 0.27 | 0.27 | 0.28 | 0.27 | 0.26 |
| ative | 1 | 0.26 | 0.27 | 0.27 | 0.28 | 0.27 | 0.26 | 0.26 |
| Example 1 | 100 | 0.28 | 0.27 | 0.26 | 0.27 | 0.27 | 0.37 | 0.28 |
| | 300 | 0.28 | 0.37 | 0.26 | 0.26 | 0.43 | 0.37 | 0.37 |
| | 500 | 0.27 | 0.28 | 0.29 | 0.39 | 0.29 | 0.50 | 0.71 |

### Example 2 Comparative Example 2

The same conduction tests were performed, by using the same contact structures as those of the Example 1 and the Comparative Example 1, except that the insulating foreign materials 5, each being substantially sperical and having an average particle diameter of 100 μm, were utilized. The test result is shown in Table 2.

TABLE 2
(Unit: V)

| | The | | | | | | | |
|---|---|---|---|---|---|---|---|---|
| | Number | | | | | | | |
| | of Times | | | | | | | |
| | The | The Number | | | | | | |
| | Switch | of Arranged Insulating | | | | | | |
| Classifi- | was | Foreign Materials | | | | | | |
| cation | pressed | 1 | 5 | 10 | 15 | 20 | 40 | 60 |
| Example 2 | 0 | 0.26 | 0.28 | 0.28 | 0.25 | 0.27 | 0.28 | 0.27 |
| | 1 | 0.27 | 0.29 | 0.28 | 0.27 | 0.27 | 0.27 | 0.27 |
| | 100 | 0.28 | 0.27 | 0.29 | 0.28 | 0.27 | 0.28 | 0.28 |
| | 300 | 0.29 | 0.29 | 0.28 | 0.28 | 0.29 | 0.28 | 0.28 |
| | 500 | 0.28 | 0.28 | 0.29 | 0.29 | 0.29 | 0.28 | 0.29 |
| Compar- | 0 | 0.26 | 0.27 | 0.26 | 0.27 | 0.29 | 0.27 | 0.26 |
| ative | 1 | 0.25 | 0.28 | 0.48 | 0.27 | NG | NG | NG |
| Example 2 | 100 | 0.28 | 0.28 | 0.26 | 0.38 | 1.01 | NG | NG |
| | 300 | 0.28 | 0.57 | 0.26 | NG | NG | NG | NG |
| | 500 | 0.27 | 0.28 | 0.29 | NG | NG | NG | NG |

Note
1) NG shows an incapable measurement due to over limiting value

### EXAMPLE 3

The same conduction test was performed by using the same contact structure as that in the Example 1 except that there was used a metal sheet 11 composed of SUS304, having a height of 50 μm, having a densed structure in form of substantially honeycomb shape having the line width of 45 μm, the space width of 380 μm, the hole area of 125054 μm²and the opening of 79.9%, and the silicone rubber has a filling rate of 20.1% and except that the insulating foreign materials 5, each being substantially spherical and having a particle diameter of 200 μm, were used. The test result 3.

### Comparative Example 3

The conduction test was performed by using the same contact structure 1 as that of the Comparative Example 1, which was manufactured with no formation of the through hole 6 to the metal sheet 11, with the same condition as that of the Example 3. The test result is shown in Table 3.

TABLE 3
(Unit: V)

| | The | | | | | | | |
|---|---|---|---|---|---|---|---|---|
| | Number | | | | | | | |
| | of Times | | | | | | | |
| | The | The Number | | | | | | |
| | Switch | of Arranged Insulating | | | | | | |
| Classifi- | was | Foreign Materials | | | | | | |
| cation | pressed | 1 | 5 | 10 | 15 | 20 | 40 | 60 |
| Example 3 | 0 | 0.38 | 0.38 | 0.34 | 0.37 | 0.37 | 0.38 | 0.39 |
| | 1 | 0.39 | 0.39 | 0.38 | 0.37 | 0.35 | 0.37 | 0.35 |
| | 100 | 0.34 | 0.39 | 0.39 | 0.38 | 0.35 | 0.37 | 0.35 |
| | 300 | 0.34 | 0.36 | 0.36 | 0.39 | 0.51 | 0.35 | 0.38 |
| | 500 | 0.37 | 0.40 | 0.39 | 0.36 | 0.34 | 0.47 | 0.39 |
| Compar- | 0 | 0.25 | 0.27 | 0.26 | 0.28 | 0.29 | 0.29 | 0.26 |
| ative | 1 | 0.24 | 0.86 | 0.58 | 0.79 | 0.65 | NG | NG |
| Example 3 | 100 | NG | NG | 1.40 | NG | NG | NG | NG |
| | 300 | NG | NG | NG | NG | NG | NG | NG |
| | 500 | NG | NG | NG | NG | NG | NG | NG |

Note
1) NG shows an incapable measurement due to over limiting value

### EXAMPLE 4

A metal sheet 11 having a densed structure, in which a number of through holes 6, each having a hexagonal shape, are arranged so as to provide a honeycomb structure, was manufactured by performing an etching treatment to a metal sheet formed of nickel having a height of 50 μm. In the thus manufactured metal sheet 11, the line width was of 60 μm, the space width was of 100 μm, hole area was of 8660 μm² and the opening was of 39.1%.

Gold plating was effected to the entire surface of the thus manufactured metal sheet 11 so as to provide a plated thickness of 0.5 μm, and thereafter, the contact structure was prepared with the same conditions as those in the Example 1 and conduction test was then performed with the same conditions as those of the Example 1. Test result is shown in Table 4.

### Comparative Example 4

The contact structure was manufactured with the same conditions as those in the Example 4 except that no through hole was formed to the metal sheet. Test result is shown in Table 4.

TABLE 4
(Unit: V)

| | The | | | | | | | |
|---|---|---|---|---|---|---|---|---|
| | Number | | | | | | | |
| | of Times | | | | | | | |
| | The | The Number | | | | | | |
| | Switch | of Arranged Insulating | | | | | | |
| Classifi- | was | Foreign Materials | | | | | | |
| cation | pressed | 1 | 5 | 10 | 15 | 20 | 40 | 60 |
| Example 4 | 0 | 0.18 | 0.16 | 0.18 | 0.16 | 0.16 | 0.18 | 0.19 |
| | 1 | 0.19 | 0.18 | 0.18 | 0.19 | 0.17 | 0.17 | 0.18 |
| | 100 | 0.18 | 0.18 | 0.19 | 0.18 | 0.18 | 0.18 | 0.21 |
| | 300 | 0.19 | 0.19 | 0.22 | 0.18 | 0.18 | 0.18 | 0.19 |
| | 500 | 0.19 | 0.19 | 0.21 | 0.21 | 0.19 | 0.19 | 0.19 |
| Compar- | 0 | 0.15 | 0.16 | 0.15 | 0.15 | 0.15 | 0.15 | 0.15 |
| ative | 1 | 0.16 | 0.15 | 0.16 | 0.16 | 0.16 | 0.19 | 0.19 |
| Example 4 | 100 | 0.19 | 0.19 | 0.23 | 0.17 | 0.23 | 0.23 | 0.28 |
| | 300 | 0.23 | 0.21 | 0.23 | 0.23 | 0.25 | 0.21 | 0.28 |
| | 500 | 0.16 | 0.16 | 0.16 | 0.28 | 0.25 | 0.26 | 0.19 |

### Example 5 and Comparative Example 5

The same conduction tests were performed, by using the same contact structures as those of the Example 4 and the Comparative Example 4, except that the insulating foreign materials 5, each being substantially spherical and having a particle diameter of 100 μm were utilized. The test result is shown in Table 5.

TABLE 5
(Unit: V)

| | The | | | | | | | |
|---|---|---|---|---|---|---|---|---|
| | Number | | | | | | | |
| | of Times | | | | | | | |
| | The | The Number | | | | | | |
| | Switch | of Arranged Insulating | | | | | | |
| Classifi- | was | Foreign Materials | | | | | | |
| cation | pressed | 1 | 5 | 10 | 15 | 20 | 40 | 60 |
| Example 5 | 0 | 0.19 | 0.18 | 0.18 | 0.18 | 0.18 | 0.18 | 0.18 |
| | 1 | 0.19 | 0.18 | 0.18 | 0.18 | 0.18 | 0.19 | 0.19 |
| | 100 | 0.18 | 0.19 | 0.18 | 0.19 | 0.19 | 0.16 | 0.18 |
| | 300 | 0.19 | 0.19 | 0.17 | 0.16 | 0.19 | 0.25 | 0.25 |
| | 500 | 0.18 | 0.18 | 0.19 | 0.18 | 0.23 | 0.25 | 0.28 |
| Compar- | 0 | 0.15 | 0.15 | 0.15 | 0.15 | 0.15 | 0.15 | 0.15 |
| ative | 1 | 0.16 | 0.16 | 0.90 | 1.3 | 1.4 | NG | NG |
| Example 5 | 100 | 0.18 | 0.15 | 0.50 | 0.38 | 1.01 | NG | NG |
| | 300 | 0.16 | 0.16 | 0.85 | NG | 1.20 | NG | NG |
| | 500 | 0.17 | 0.17 | 0.17 | 0.98 | NG | NG | NG |

Note
1) NG shows an incapable measurement due to over limiting value

As can be seen from Tables 1 to 5, in the Comparative Examples 1 to 5 in which the metal sheet provided with no through hole was utilized, large voltage drops were indicated in the cases where the insulating foreign material 5 becomes larger, the number of existing insulating foreign materials 5 is increased and the number of times the switch was pressed is increased.

On the other hand, in the Examples 1 to 5 in which the contract structure 1 provided with through holes 6 were utilized, the voltage drop values did not show large change and were stabled.

Furthermore, in comparison with the Examples 1 to 3 in which the metal member 7 of the contact structure 1 was formed of stainless steel, in the Examples 4 and 5 in which the metal member 7 was formed of nickel, the small voltage drop was observed and, hence, the push-button switch member 1 having better conductivity was produced.

Further, in view of the test results of the Examples 1 to 5 and Comparative Examples 1 to 5, it was confirmed that, in the case of using the insulating foreign materials, having substantially spherical shape, mainly including ones each having a particle diameter of 50 to 100 μm, which are liable to adhere at the using time of the push-button switch of a portable phone, the use of a metal member having the space width of 100 to 400 μm and the opening of 30 to 90% was preferably desirable.

### EXAMPLE 6

There were manufactured contact structures 1, each formed of material of SUS304, having the line width of 20 μm, the space width of 185 μm and the hole area of 29640 μm² and using a densed honeycomb structure and a mesh structure (line diameter of 20 μm) by the same method as in the Example 1.

Push-button switch members were prepared by using such contact structures 1, and outer appearance and resistance thereof, after pressing them with load of 200 g and with no current load, were compared. The evaluation of the outer appearance was made by visually observing the contacting surface and one having injury or defect was considered to be bad (X). The evaluation of the resistance was made by observing sparks which was generated at the time of lowering of the insulating resistance between two patterns on the stationary substrates 3 and when the spark was observed, it was considered to be bad or defective (X). The results are shown in Table 6.

### EXAMPLE 7

There was manufactured contact structure 1 with substantially the same conditions as those in the Example 6 except for the line width of 30 μm, the space width of 175 μm and the hole area of 26522 μm² and the comparison was made between the honeycomb shape densed structure and the mesh structure (wire diameter of 30 μm). The result is shown in Table 6.

TABLE 6
(Unit: V)

| | The | | | | |
|---|---|---|---|---|---|
| | Number | | | | |
| | of | | | | |
| | Times | | | | |
| | the | | | Honeycomb | |
| | Switch | Mesh Structure | | Densed Structure | |
| | was | Outer | | Outer | |
| | pressed | Appearance | Resistance | Appearance | Resistance |
| Example 6 | 5 | x | ∘ | ∘ | ∘ |
| | 10 | x | x | ∘ | ∘ |
| | 50 | x | x | ∘ | ∘ |
| | 10⁶ | x | x | x | x |
| Example 7 | 5 | x | ∘ | ∘ | ∘ |
| | 10 | x | ∘ | ∘ | ∘ |
| | 50 | x | x | ∘ | ∘ |
| | 10⁶ | x | x | ∘ | ∘ |

As can be seen from Table 6, the contact structure utilizing the honeycomb shape densed structure provided the excellent durability as compared with the contact structure utilizing the mesh structure.

Since the contact structure of the mesh structure has, on its contact surface, a number of recessed portions penetrating in the height direction, advantageous effect to foreign materials could be expected as well as the contact structure of the honeycomb shaped structure. However, since the vertical and horizontal wires of the mesh structure is inferior in the durability, this is not available for the use requiring the durability though being applicable to the push-button switch which does not require the durability so much.

In addition, from Table 6, it is confirmed that the contact structure in the case of the honeycomb shape densed structure could provide the usable durability as far as it has the line width of 20μm. However, it is difficult to manufacture the structure having the line width of less than 20 μm, so that it is desired that the structure has the line width of not less than 20 μm.

### Industrial Applicability

According to the present invention, it is possible to provide the push-button switch member hardly causing the conductive fault even in the presence of the fine insulating foreign material. It could therefore be preferably utilized as a push-button switch member, such as one utilized for a power window, door mirror or like, having a contact to which high electric current passes or one having a normally closed type contact for which it is required to prevent a sticking phenomenon.

1. A member for push-button switch having a movable contact made of a metal member consisting a contact surface to be contacted to an opposing electrode, wherein a number of holes are formed to the contact surface so as to extend in a height direction thereof and the holes are filled up with a filler formed of flexible resin.

2. A member for push-button switch according to claim 1, wherein said through holes are filled up with the filler in a full height direction of the metal member.

3. A member for push-button switch according to claim 1 or 2, wherein said metal member has a honeycomb shape densed structure formed with a number of through holes having same sectional shape.

4. A method of manufacturing a member for push-button switch provided with a movable contact composed of a metal member constituting a contact surface to an opposing electrode, comprising the steps of forming a number of through holes to the metal member so as to penetrate in a height direction thereof, arranging a filler formed of a flexible resin sheet on one end surface side of the metal member, forming a metal member base material in which the through holes are filled up with the filler in the full height direction amount by pressurizing the metal member in the height direction thereof, punching out the metal member base material so as to provide a contact structure having a predetermined shape, and joining the contact structure to a keypad.
